(19) United States
(12) Patent Application Publication
(10) Pub. No.: US 2014/0055914 A1
(43) Pub. Date: Feb. 27, 2014

(54) INTEGRATION OF A SERVICE CABINET INTO A STREET FURNITURE

(71) Applicant: Paul W. Fournier, Mascouche (CA)

(72) Inventor: Paul W. Fournier, Mascouche (CA)

(21) Appl. No.: 14/114,602

(22) PCT Filed: Apr. 30, 2012
(86) PCT No.: PCT/CA2012/000426

§ 371 Date: Oct. 29, 2013

Related U.S. Application Data
(60) Provisional application No. 61/480,652, filed on Apr. 29, 2011.

(51) Int. Cl. H02B 1/50

(52) U.S. Cl. CPC H02B 1/50
USPC 361/601

(57) ABSTRACT

A service cabinet (14) adapted to house power distribution equipment and the like is disposed inside the internal volume of the external envelope (42, 44) of a street furniture, namely an advertising pillar (10). The external envelope (42, 44) may be used to display advertisements while at the same time concealing the service cabinet (14) and the distribution equipment housed therein. At least one door (22, 44) is provided for allowing authorized personnel to access the service equipment.

### TECHNICAL FIELD

The present application generally relates to street furniture and, more particularly, to the integration of electrical enclosures and the like into a public environment.

### BACKGROUND ART

It has always been challenging to minimize the visual impact of the implantation of power and telecom distribution equipment, including service cabinets, electrical enclosures and the like, in a public environment. While there is an ever increasing need for new equipment and services, such as for the electrification of transport and for smart grid interfacing units, the installation thereof must be done in a way to minimize their environmental impact. Urban environments are already crowded with various equipment and signs and the space available for the implantation of new structures is becoming increasingly rare. More specifically, electrification of buses and tramways necessitate the deployment of large capacity DC power infrastructures, either in the ground or above ground. In either case, this requires the installation of interconnecting points every two kilometers or so where AC energy from the grid is transform into DC energy to be transferred to the electric vehicles, either tramways, e-buses, or e-cars. Each of the interconnecting point requires about three cubic meters of electrical components to be installed inside the public domain, preferably above ground given its sensitive nature.

Alternately, the smart grid concept aims at interconnecting local energy sources (like solar panels, wind turbines, etc.) to the grid, also called power distribution network, this in order to reduce the need for new remote polluting power plants. Interconnecting such smart grid components is best achieved in the public domain using electrical enclosures of various types.

There is thus a need for new solutions to provide harmonious integration of new power distribution and interconnection enclosures into a public landscape. Further, given the similarities of the required equipment to achieve these two above-described projects, there is a possibility to also consider multi-functionality for such an enclosure, for example to be used simultaneously for electrification of transport and smart grid interconnection as well. There is also a need for other enclosure applications.

### SUMMARY

Therefore, in accordance with a general aspect of the present application, there is provided a street furniture having an external envelope defining an internal volume, a service cabinet disposed in said internal volume, the service cabinet being substantially concealed inside the external envelope for housing distribution equipment, and at least one door selectively openable by authorized personnel to access the service equipment.

In accordance with another aspect, there is provided a multi-function street furniture for installation in an outdoor urban environment, the street furniture comprising: an advertising pillar having an external envelope extending upwardly from a base, the external envelope defining an internal volume, the internal volume having a generally vertically oriented longitudinal axis, the external envelope having at least one advertising panel displaying advertisements and at least one door for providing access to said internal volume, a weatherproof electrical cabinet erected on said base inside said external envelope, the electrical cabinet being accessible via said at least one door, electrical equipment housed in said electrical cabinet and concealed within the advertising pillar, the electrical equipment being selected from a group consisting of: power and telecom distribution equipment, equipment for electrification of transport, smart grid interfacing unit, or a combination thereof, the electrical cabinet having an air intake at a lower end portion thereof for admitting fresh outside air into the electrical cabinet to cool down the electrical equipment, and a vent at an upper end portion thereof for discharging the air admitted into the electrical cabinet back into the atmosphere.

In accordance with another aspect, there is provided a multi-function outdoor sidewalk structure comprising a base adapted to be anchored to a ground surface, an electrical cabinet mounted to said base, said electrical cabinet having a set of side panels extending between top and bottom panels, at least one of said side panels being pivotable between open and closed positions to selectively provide access to an internal space of said electrical cabinet, an advertising column built around the electrical cabinet, the advertising column comprising a set of advertising panels mounted to the side panels of the electrical cabinet, the advertising panels concealing the electrical cabinet within the advertising column and having an external surface displaying advertisements, at least one of the advertising panel being pivotable to selectively expose the at least one pivotable side panel of the electrical cabinet, a roof covering both said electrical cabinet and said advertising column, and air inlet and outlet means for providing ventilation to said electrical cabinet.

In accordance with a further general aspect, there is provided an advertising pillar having a generally cylindrical or polygonal external envelope used to display advertisements, the external envelope having at least one door for providing access to a service cabinet built inside the external envelope for concealing distribution equipment within the internal volume of the advertising pillar.

### BRIEF DESCRIPTION OF THE DRAWINGS

Reference will now be made to the accompanying drawings, showing by way of illustration a preferred embodiment of the invention, and in which:

FIG. 1 is an elevation view of a multi-function pillar in accordance with a preferred embodiment of the present invention;

FIG. 2 is an exploded isometric view of the multi-function pillar shown in FIG. 1;

FIG. 3 is a top isometric view of the multi-function pillar with some of the external parts thereof omitted and illustrated with the door panels opened to reveal internal details of the multi-function pillar; and

FIG. 4 is an elevation view of the internal cabinet structure of the multi-function pillar shown in FIG. 1.

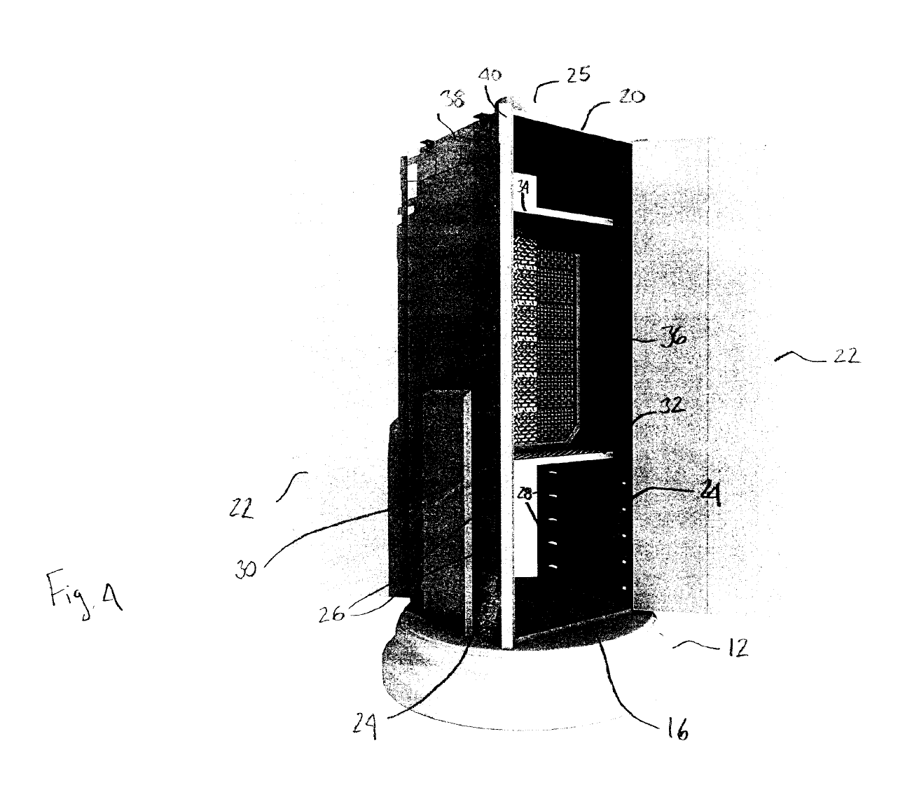

### DESCRIPTION OF THE PREFERRED EMBODIMENTS

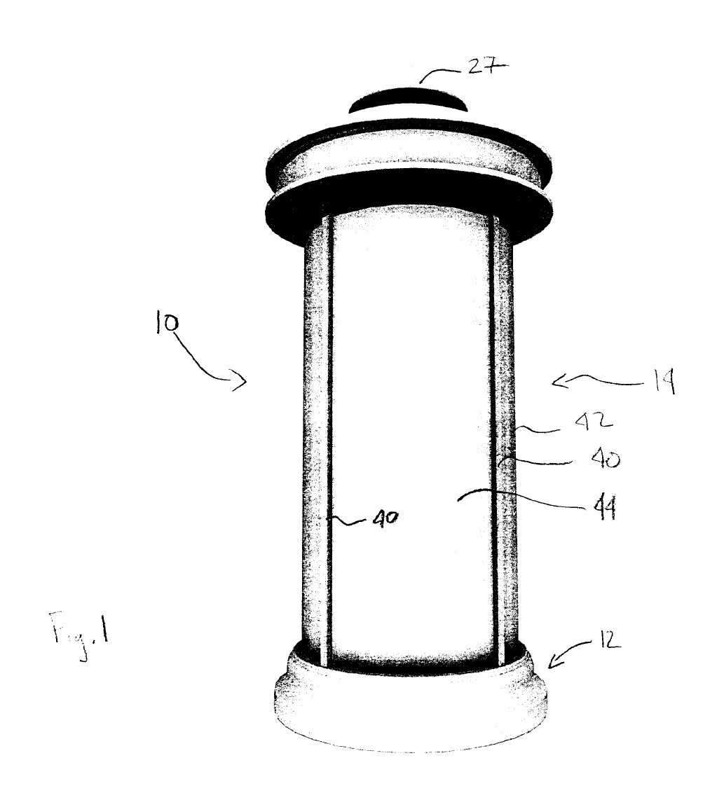

FIG. 1 illustrates a street furniture in the form of an advertising pillar 10 (also know as a Morris column) which is specifically designed to form part of an electrical energy distribution infrastructure. According to an embodiment of the present invention, the advertising pillar 10 may be used as a column-shaped enclosure for housing both electrical distribution equipment and power conditioning equipment. For instance, the advertising pillar 10 may house storage Battery Management System (BMS) connecting a nearby battery bank to store electrical energy for use at a later time, thereby allowing for efficient and smart grid network operation. Equipment inside the pillar 10 may comprise a section with AC panel boards with breakers, an inverter to rectify AC energy into DC energy for storage in batteries and then to invert the DC energy back into AC energy in response to a power demand, monitoring and control equipment, filters and transformers. The pillar 10 provides a solution to the integration of such systems in a public environment by avoiding the installation of numerous separate pad-mounted enclosures. The equipment housed in the advertising pillar 10 can also advantageously be used to supply power to electric buses, tramways, or electric vehicles charging stations installed along the street or in a public parking area. The equipment in the pillar 10 could be connected to the charging stations by means of underground distribution lines. The integration of multiple functions, namely advertising, smart grid, and electric vehicle charging functions into one piece of street furniture contributes to unencumbered urban landscapes and so allows easy deployment in most outdoor public area. It can be appreciated that such a multi-function pillar 10 allows reducing clutter in an urban environment by consolidating multiple infrastructure types into a single street furniture, while being flexible enough to feed various types of desired infrastructures, either overhead or underground, including feeding charging induction systems embedded in the pavement.

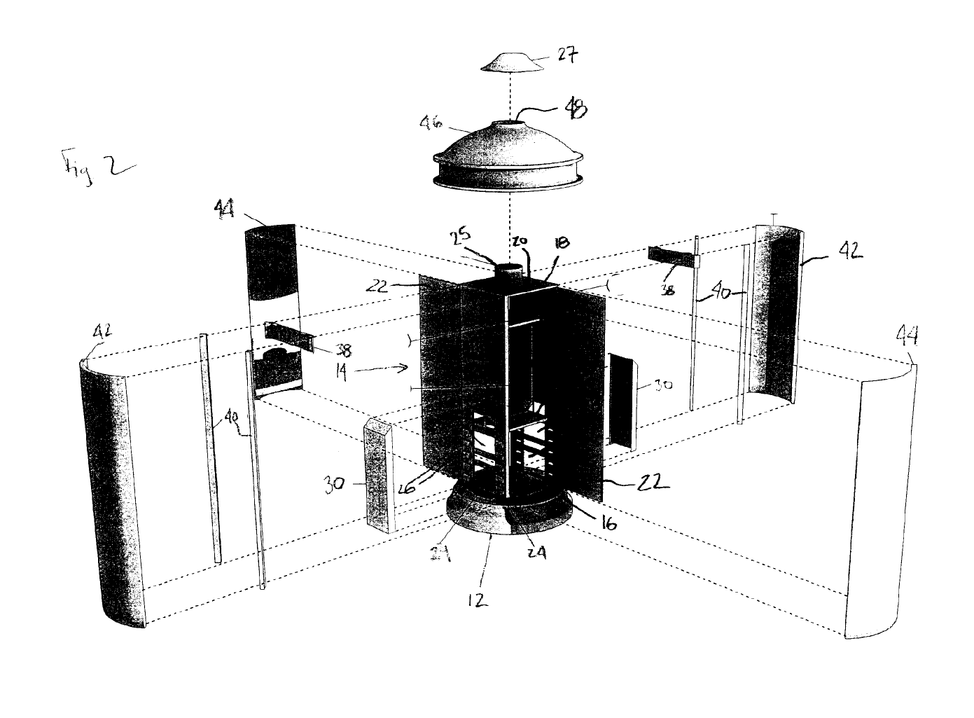

As shown in FIG. 1, the advertising pillar 10 generally comprises a base 12 and an upstanding electrical enclosure or weatherproof service cabinet 14 mounted on the base 12. The base 12 and the cabinet 14 may be made out of aluminum or steel. According to one embodiment, the cabinet may have a storing capacity of about 3 m³ (three cubic meters). The base 12 is adapted to be anchored to a ground surface, typically a sidewalk or other paved surfaces. The base 12 may have an open-ended bottom for allowing equipment housed in the cabinet 14 to be connected with underground power distribution lines. In the example illustrated in FIG. 2, the cabinet 14 is provided in the form of an upstanding rectangular box having a bottom plate 16 adapted to be securely mounted to the top surface of the base 12, two side panels 18 extending vertically upwardly from the bottom plate 16, a top plate 20 mounted at an upper end of the side panels 18 and two door panels 22 hinged to respective side panels 18 to provide access to the internal volume of the cabinet 14 on either side. Air inlet louvers 24 defining series of vertically spaced-apart slatted apertures are provided at the lower end portion of each side panel 18 for admitting cooling air inside the cabinet 14. Each louver 24 has a set of slanted fins 26 to prevent rain or snow from entering the cabinet 14. A chimney 25 is provided on the top panel 20 for venting the cooling air to the atmosphere. A fan or air conditioning unit (not shown) may be mounted on shelf 34 in the upper portion of the cabinet 14 for cooling or drawing fresh outside air into the cabinet 14 via the louvers 24. However, it is understood that the natural upward flow of air through the cabinet 14 between the louvers 24 and the chimney 25 may in some instances be sufficient to adequately cool the equipment housed inside the cabinet 14. A thermostat inside the enclosure may be provided to regulate the inside temperature by activating the fan or the air conditioning unit when required. During the winter, heat from the equipment housed inside the cabinet will generally suffice to maintain a proper internal temperature. However, it is understood that a heating element can also be added if judged necessary. A bonnet or chimney hood 27 is provided at the top of the chimney 25 to prevent rain and snow from entering into the cabinet 14 via the chimney 25. Elongated openings 29 may be defined in the top surface of the base 12 laterally outside of the side panels 18 for receiving cables and wires used for connecting the equipment housed in the cabinet 14 with the underground distribution network. The wires extending through the elongated openings 29 defined in the top surface of the base 12 are received in wiring expansion cartridges 30 mounted on the outer surface of the side panels 18. The cartridges 30 are mounted over a plurality of vertically spaced-apart rectangular openings 28 defined in the lower end portion of the side panels 18. The wires received in the wiring expansion cartridges 30 may extend through the openings 28 for connection to the equipment inside the cabinet 14.

Partitions and shelves may be provided inside the cabinet 14 to support the equipment in different compartments. The different compartments could be used for different services. In the illustrated example, the cabinet 14 has two shelves 32, 34 defining a volume separated in two parts by a central partition 36 extending vertically between the shelves 32, 34. Shelves 32 and 34 as well as the central upstanding partition 36 may each be provided in the form of a grating for allowing the cooling air to flow therethrough.

As will be seen hereinafter, the cabinet 14 is dressed with a set of curved or folded panels 42, 44 which jointly form an external envelope or shell offering a cylindrical or polygonal display surface. The cabinet 14 is concealed within the internal volume of the external envelope of the pillar 10 (FIG. 1).

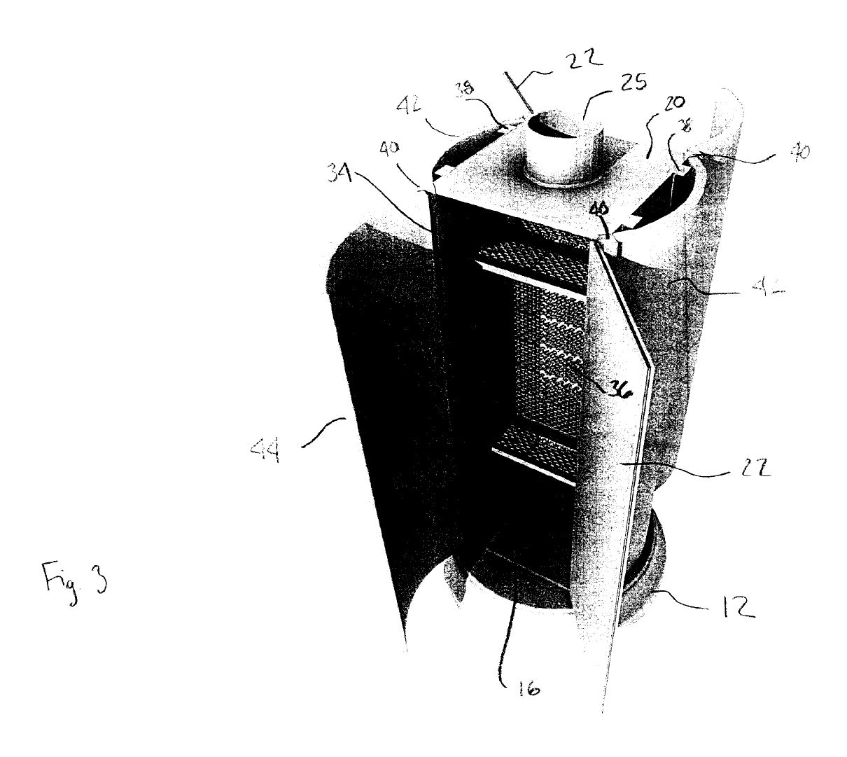

Transversal rails 38 are mounted to the outer surface of the side panels 18 along the top edge region thereof. Vertical structural legs 40 extend along the longitudinal side edges of the side panels 18. The vertical legs 40 are fastened at their upper end thereof to the transversal rails 38. A fixed curved or folded panel 42 is mounted between each pair of vertical legs 40. A similar door panel 44 is hingedly mounted to an associated one of the vertical legs 40 to close over the flat door panels 22 of the cabinet 14. As shown in FIG. 3, the arcuate door panels 44 are mounted to the vertical leg 40 which is opposite to the side to which the flat door panel 22 of the cabinet 14 is mounted. To have access to the interior of the cabinet 14, the authorized personnel has to first open one of the arcuate door panels 44 so as to expose the flat door panel 22 which was concealed thereunder and then pivot the flat door panel 22 to its open position. It is understood that locks are provided to prevent non-authorized opening of the door panels.

The outer surface of the fixed panels 42 and the pivotable door panels 44 form the cylindrical or polygonal outer surface of the advertising pillar 10. The outer surface of panels 42 and 44 may be used to display advertisements in the form of posters or the like. Alternatively, arcuate display screens, such as LED screens, could be provided on the outer surface of the panels 42 and 44 to provide a multi-media advertising pillar or column.

A dome-shaped roof 46 is fastened on top of the cabinet 14 for covering the space between the arcuate panels 42 and 44 and the cabinet panels 28 and 22. A central opening 48 is defined in the roof to accommodate the chimney 25.

The above described structure allows integrating different functions into a single structure. The advertising pillar 10 with its integrated cabinet 14 allows to house service equipment which would otherwise have to be housed in separate and dedicated enclosures.

The concept presented in the present description and also claimed in the appended set of claims is not limited to the example shown and described. The shape of the cabinet can be different from what is shown in the figures. The cabinet could be otherwise built inside the internal volume of the external shell of the advertising pillar 10. The cabinet could also be integrated to different street furniture having none-exploited internal volumes. Also the integrated cabinet could be used for storing a wide variety of items, including items related to communication networks and/or power distribution. Still, other modifications and variants, which fall within the scope of the appended claims, can be devised as well.

1. A multi-function street furniture for installation in an outdoor urban environment, the street furniture comprising: an advertising pillar having an external envelope extending upwardly from a base, the external envelope defining an internal volume, the internal volume having a generally vertically oriented longitudinal axis, the external envelope having at least one advertising panel displaying advertisements and at least one door for providing access to said internal volume, a weatherproof electrical cabinet erected on said base inside said external envelope, the electrical cabinet being accessible via said at least one door, electrical equipment housed in said electrical cabinet and concealed within the advertising pillar, the electrical equipment being selected from a group consisting of: power and telecom distribution equipment, equipment for electrification of transport, smart grid interfacing unit, or a combination thereof, the electrical cabinet having an air intake at a lower end portion thereof for admitting fresh outside air into the electrical cabinet to cool down the electrical equipment, and a vent at an upper end portion thereof for discharging the air admitted into the electrical cabinet back into the atmosphere.

2. The multi-function street furniture defined in claim 1, wherein the electric equipment comprises both equipment for the electrification of transport and smart grid interfacing unit.

3. The multi-function street furniture defined in claim 2, wherein the smart grid interfacing unit comprises a storage Battery Management System (BMS) connecting a nearby battery bank to a power distribution infrastructure.

4. The multi-function street furniture defined in claim 1, wherein the electrical cabinet comprises side panels, wherein the air intake comprises air inlet louvers defining series of vertically spaced-apart slatted apertures at lower end portions of at least one of said side panels, and wherein said air inlet louvers open to an air gap defined between the external envelope of the advertising pillar and the electrical cabinet.

5. The multi-function street furniture defined in claim 4, wherein a roof is positioned on top of the electrical cabinet, the roof covering the air gap between the electrical cabinet and the external envelope, and wherein the vent comprises a chimney extending upwardly from the electrical cabinet through the roof for venting the cooling air to the atmosphere.

6. The multi-function street furniture defined in claim 1, wherein the at least one advertising panel of the external envelope comprises a set of curved panels mounted to the electrical cabinet, and defining therewith a series of gaps along a perimeter of the electrical cabinet, transversal rails and vertical structural legs projecting into said gaps for mounting said curved panels to said electrical cabinet.

7. The multi-function street furniture defined in claim 6, wherein at least one of said curved panels is hingedly mounted to an openable side panel of the electrical cabinet.

8. The multi-function street furniture defined in claim 1, wherein the at least one advertising panel comprises a display screen, thereby providing for a multi-media advertising pillar.

9. The multi-function street furniture defined in claim 1, wherein elongated openings are defined in a top surface of the base laterally outside of the electrical cabinet but inside the external envelope of the advertising pillar for receiving wires used for connecting the electrical equipment housed inside the cabinet with an underground infrastructure, the wires extending through the elongated openings into wiring expansion cartridges mounted on an outer surface of the electrical cabinet, the wiring expansion cartridges being mounted over openings defined in the electrical cabinet.

10. The multi-function street furniture of claim 1, wherein the electrical equipment comprises at least two different types of equipment among the equipment of said group.

11. A multi-function outdoor sidewalk structure comprising a base adapted to be anchored to a ground surface, an electrical cabinet mounted to said base, said electrical cabinet having a set of side panels extending between top and bottom panels, at least one of said side panels being pivotable between open and closed positions to selectively provide access to an internal space of said electrical cabinet, an advertising column built around the electrical cabinet, the advertising column comprising a set of advertising panels mounted to the side panels of the electrical cabinet, the advertising panels concealing the electrical cabinet within the advertising column and having an external surface displaying advertisements, at least one of the advertising panel being pivotable to selectively expose the at least one pivotable side panel of the electrical cabinet, a roof covering both said electrical cabinet and said advertising column, and air inlet and outlet means for providing ventilation to said electrical cabinet.
